(19) United States
(12) Patent Application Publication
(10) Pub. No.: US 2013/0018965 A1
(43) Pub. Date: Jan. 17, 2013

(54) REPUTATIONAL AND BEHAVIORAL SPAM MITIGATION

(71) Applicants: Aravind K. Ramachandran, Redmond, WA (US); Malcolm Hollis Davis, Kirkland, WA (US); Mihai Costea, Redmond, WA (US)

(72) Inventors: Aravind K. Ramachandran, Redmond, WA (US); Malcolm Hollis Davis, Kirkland, WA (US); Mihai Costea, Redmond, WA (US)

(73) Assignee: Microsoft Corporation, Redmond, WA (US)

(21) Appl. No.: 13/180,877

(22) Filed: Jul. 12, 2011

(51) Int. Cl. G06F 15/16

(52) U.S. Cl. 709/206

(57) ABSTRACT

One or more techniques and/or systems are provided for identifying abusive message objects (e.g., URLs, email addresses, etc.), abusive infrastructure components and/or abusive users of a message communication medium(s). In particular, abusive message objects may be identified by aggregating abuse reports to assign abuse values to message objects used within messages by reported users identified within the abuse reports. Abusive users may be identified based upon (e.g., unreported) users that have sent messages comprising message objects identified as abusive. Users may also be identified as abusive users based upon account usage patterns within the message communication medium(s) (e.g., a broadcast usage pattern where a user sends a large number of messages, but receives few responses). Additionally, infrastructure components associated with abusive users may be identified as abusive infrastructure components. In this way, abusive content, such as spam, may be identified and/or mitigated within the message communication medium(s).

### BACKGROUND

Today, spam is a prevalent issue that affects multiple communication mediums, such as email, instant message communication, short message service (SMS), social network communication, etc. For example, a large percentage of URLs sent within instant messages may link to spam websites. Current solutions provide spam filters that are based upon URLs. For example, if a spam filter detects a known spam URL within a message (e.g., a spam URL defined within a blacklist), then the spam filter may block the spam URL and/or the message. Current solutions may also provide an abuse reporting mechanism. The abuse reporting mechanism may allow users to report abusive users, messages, and/or URLs. Unfortunately, abuse report logs may comprise sparse data because many users do not report abuse. For example, users may report 1 out of every 500 instances of abuse. Typically, an account may be blocked after a threshold number of abuse reports are accumulated (e.g., 5 abuse reports). Thus, as an example, an abusive account may engage in 2,500 instances of abuse (e.g., 500 unreported instances of abuse multiplied by 5 abuse reports accumulated over time) before the abusive account is blocked. In this way, spam and/or other forms of abuse may be highly profitable at such levels.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for identifying abusive message objects, abusive infrastructure components, and/or abusive users of a message communication medium are disclosed herein. It may be appreciated that the message communication medium may comprise a wide variety of electronic communication mediums, such as email, instant message communication, short message service (SMS), social network communication, etc. Such message communication mediums may allow users to communicate with one another by sending and receiving online and/or offline messages. A message may comprise message objects, such as text, URLs, phone numbers, images, email addresses, social network links and/or other objects that may be used within a message. It may be advantageous to identify and/or block message objects, users and/or network infrastructure components of users that engage in abusive activity such as sending abusive message objects. For example, abusive message objects may correspond to URLs linking to spam websites, phone numbers linking to abusive phone centers, email addresses linking to abusive email accounts, social network links linking to abusive social network data, etc.

Accordingly, an abusive message object may be identified by aggregating abuse reports against users of a message communication medium. In particular, a message object list comprising one or more message objects used within messages of the message communication medium may be defined (e.g., a communication history log may be parsed to identify message objects used within messages sent by users). Message objects within the message object list may be associated with abuse values (e.g., an abuse value may comprise reputational data indicating a likelihood that a corresponding message object may comprise malicious content and/or link to malicious content).

It may be appreciated that users may be reported by other users through abuse reports (e.g., a user reports another user for sending a message comprising a malicious URL). Because abuse reports may be filed infrequently, it may be advantageous to aggregate (data derived, generated, etc. from) a plurality of abuse reports against users (e.g., reported users) of the message communication medium to assign (e.g., increment) abuse values for message objects. That is, abuse reports (e.g., data therefrom) may be iteratively processed to assign, adjust, etc. abuse values of message objects. In one example of processing an abuse report, one or more messages sent by a reported user may be identified. For example, user (A) may be identified within an abuse report, and thus messages comprising at least one message object sent by user (A) within 15 days of the abuse report may be identified. Because the identified messages sent by the reported user may also comprise abusive message objects, abuse values within the message object list for message objects associated with the identified messages sent by the reported user may be incremented. For example, a message of a user A may have been reported as abusive, and thus abuse values of message objects comprised within other messages sent by user A within 15 days of the abuse report may be incremented because such message may also be associated with abusive content even though such messages may not have been reported as abusive. As such, the message object list may be updated based upon the processed abuse report (e.g., abuse values may be incremented, decremented, assigned, and/or updated). Accordingly, one or more additional abuse reports may also be processed to increment abuse values of message objects. In this way, an abusive message object list may be defined based upon message objects within the message object list having abuse values above a threshold.

It may be appreciated that abuse values of message objects within other messages sent by the reported user (e.g., sent within certain time span of the message that was reported as abusive) may be incremented because there may be a high likelihood that such message objects of the reported user may also be abusive, but were merely not reported (e.g., the reported user may have a propensity to send abusive messages because the user has been reported at least once already, but not all of the abusive messages have been reported).

It may be appreciated that abusive users and/or abusive infrastructure components associated with abusive users may be identified. It may be appreciated that an infrastructure component may comprise a URL rollup (e.g., “www.domain.com/abuse/*” may be used to identify a plurality of other URLs starting with “www.domain.com/abuse/”, such as “www.domain.com/abuse/path1” and/or “www.domain.com/abuse/path2”), a hostname, a domain, an IP address associated with a login of a user, an IP address associated with a message sent by a user, an IP address associated with a website and/or a host that hosts a URL, an IP range, a name server (e.g., a DNS name server), a site owner associated with an autonomous system number (ASN) and/or other network infrastructure components. In one example of identifying abusive users, users may be associated with abuse values, which may be incremented based upon various factors (e.g., the user may be associated with messages within the abusive message object list, the user is a broadcast user that sends a large number of messages without response, etc.). The abuse values assigned to users may correspond to reputational data (e.g., a high abuse value may indicate that a user has a propensity to send abusive content to other users).

In another example of identifying abusive users, a user may be identified as an abusive user based upon the user being associated with one or more abusive message objects defined within the abusive message object list (e.g., user B may have sent at least 5 messages within a month that comprise message objects within the abusive message object list, and thus user B may be deemed an abusive spammer).

In another example of identifying an abusive user, a reported user may be identified as an abusive user based upon the reported user being associated with a broadcast usage pattern within the message communication medium. The broadcast usage pattern may indicate that the reported user sends a number of messages without action by recipient users above a threshold (e.g., user D may send a thousand instant messages to recipient users, and may receive less than thirty responses). In another example of identifying an abusive user, a reported user may be identified as an abusive user based upon the user sending a number of unaccepted friend invites to other users above a predetermined threshold (e.g., less than 5% of friend invites of user E are accepted).

It may be appreciated that other factors associated with a reported user may be used to identify the reported user as an abusive user. In one example, a reported user may be identified as an abusive user if the reported user logs into the message communication medium a number of times above a threshold within a time span (e.g., user F may be an abusive user if user F logs in/out of the message communication medium an abnormal number of times, such as more than a 100 times spanning daytime and nighttime hours of a 24 hour period). In another example, a reported user may be identified as an abusive user if the reported user logs in from different IP address and/or geographical locations above a threshold (e.g., user G may login from Cleveland, and then login from South Africa 10 minutes later, and then other various locations within a short time span, which may indicate that multiple abusive users are utilizing the account for abusive activity). In another example, a reported user may be identified as an abusive user if a number of offline messages is greater than a number of online messages above a threshold (e.g., non-abusive users of an instant message communication medium may tend to communicate online, whereas abusive users may broadcast large number of offline messages).

Infrastructure components associated with abusive users may be identified as abusive infrastructure components (e.g., a domain of abusive user B may be identified and/or blocked, a DNS name server of abusive user C may be identified and/or blocked, etc.).

If a user and/or infrastructure component is identified as abusive, then one or more of a variety of techniques may be employed to block and/or limit the abuse. In one example, an abusive account may be blocked. In another example, an abusive infrastructure component may be blocked. In another example, a send rate of an abusive user may be throttled based upon an abuse value of the user. It may be appreciated that multiple communication mediums may be leveraged when identifying abusive message objects, users, and/or infrastructure components. For example, a universal message object list and/or a universal abusive message object list may be maintained and/or updated from messages and/or abuse reports associated with instant message communication, email communication, and/or other communication medium. It may be appreciated that potentially abusive users, infrastructure components and/or message objects (and/or abuse values associated therewith) may be dynamically identified, adjusted, etc. as communication occurs (e.g., messages are sent and/or received) within one or more communication mediums and/or abuse reports are iteratively processed, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of identifying abusive message objects used within messages.

FIG. 2 is a flow chart illustrating an exemplary method of identifying an abusive user of a message communication medium.

FIG. 3A is an illustration of an example of a sender sending a message comprising a URL message object to a recipient using an SMS communication medium.

FIG. 3B is an illustration of an example of a sender sending a first message comprising a phone number message object to a first recipient, and a second message comprising an email message object to a second recipient using an instant message communication medium.

FIG. 4 is an illustration of an example of a communication history log and an abuse report log.

FIG. 5 is a component block diagram illustrating an exemplary system for identifying abusive message objects used within messages by users of a message communication medium.

FIG. 6 is an illustration of an example of a message object list.

FIG. 7 is an illustration of an example of an abusive message object list.

FIG. 8 is an illustration of an example of an abusive user identifier defining an abusive user and infrastructure component list.

FIG. 9 is an illustration of an example of an abusive user identifier defining an abusive user and infrastructure component list.

FIG. 10 is an illustration of an exemplary computer-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Message communication mediums spend a substantial amount of resources detecting and/or eliminating abusive content, such as unsolicited and/or malicious spam. Unfortunately, current techniques, such as spam filters and/or abuse reporting, have not sufficiently deterred abuse within such message communication mediums. In one example, an abusive user may hide behind a plurality of user accounts and/or URLs, such that closing a single account and/or blocking a single URL may not stop the abusive conduct. Thus, it may be advantageous to detect and/or block abusive network infrastructure, such as IP addresses, name servers, domains, etc. In another example, users may tend to ignore spam, as opposed to reporting spam through an abuse reporting mechanism. Accordingly, abusive users may be able to engage in substantial abusive conduct because not enough abuse report data is collected to identify and/or block the abusive users. Thus, it may be advantageous to aggregate abuse reports to message objects (e.g., URLs), users and/or infrastructure components.

Accordingly, one or more systems and/or techniques for identifying abusive message objects, abusive infrastructure components and/or abusive users of a message communication medium are provided herein. In particular, abusive message objects may be identified by aggregating abuse reports for users of the message communication medium and/or other message communication mediums. For example, abuse values may be assigned and/or incremented for message objects comprised within messages sent by reported users identified within abuse reports. In this way, message objects having abuse values above a threshold may be deemed to be abusive message objects (e.g., spam URLs). Additionally, abusive users and/or infrastructure components may be identified based upon one or more of a variety of factors. In one example, users that have sent messages comprising message objects within the abusive message object list may be identified as abusive users. In other example, broadcast usage patterns, unaccepted friend invites, account usage behaviors and/or other factors may be used to identify abusive users. Infrastructure components associated with abusive users may be identified as abusive infrastructure components. In this way, various actions, such as account cancelling, content blocking and/or message rate throttling, for example, may be taken upon abusive message objects, users and/or infrastructure components.

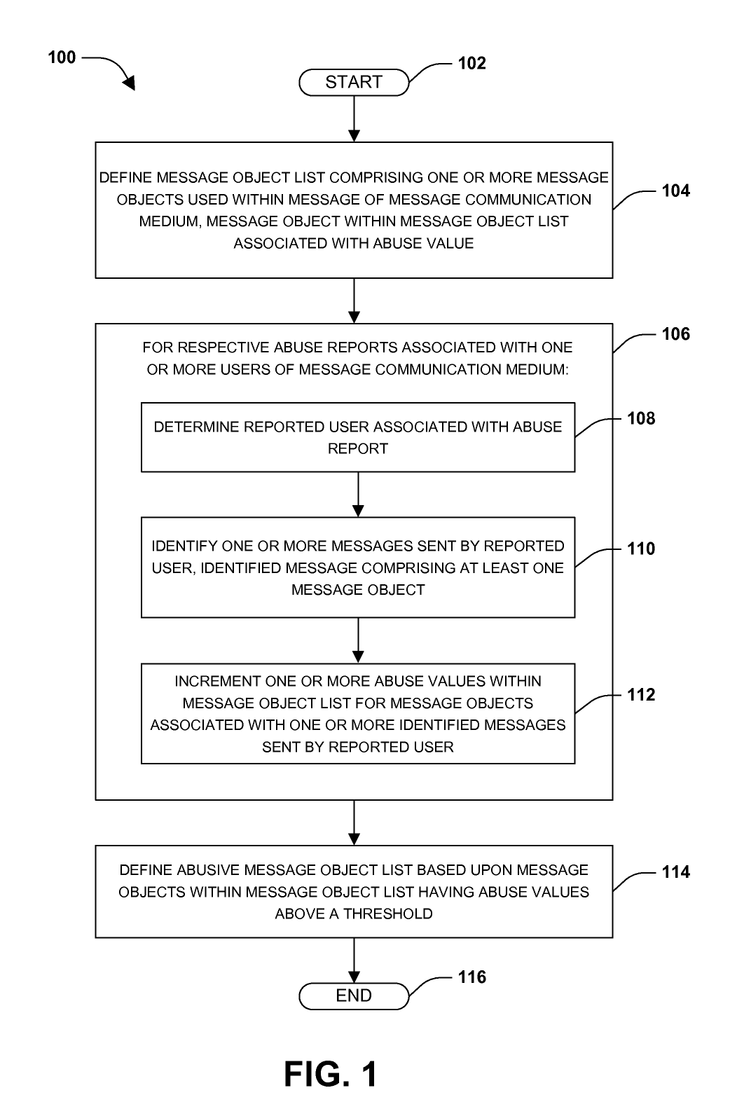

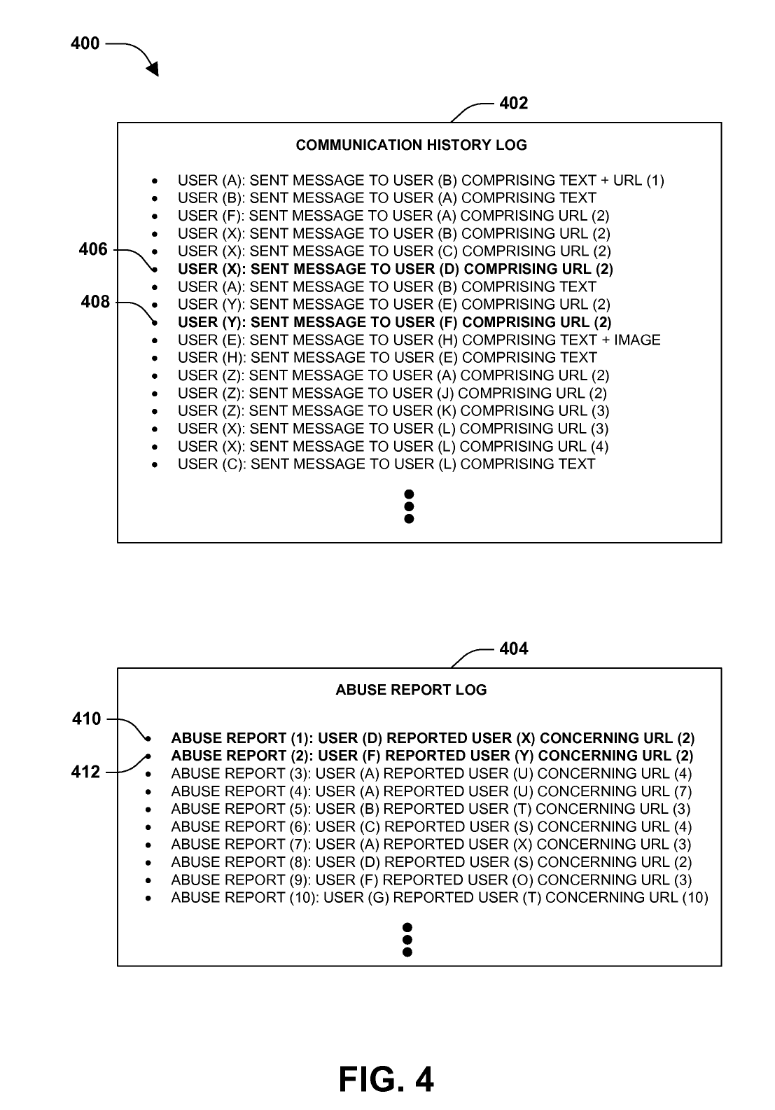

One embodiment of identifying abusive message objects used within messages is illustrated by an exemplary method 100 in FIG. 1. At 102, the method starts. It may be appreciated that a message communication medium may comprise instant message communication, email communication, social network communication, short message service (SMS) communication and/or other types of electronic message communication. Such message communication mediums may allow users to send and/or receive online and/or offline messages. Users may add message objects, such as URLs, email addresses, phone numbers, social network links and/or other content into such messages. Unfortunately, many of these message objects may be abusive and/or link to abusive content. A message communication medium may store message data within a communication history log (e.g., message communication log 402 of FIG. 4, a table, a database, a log file, etc.). The communication history log may comprise a variety of data associated with messages, such as message content (e.g., message objects comprised within messages), message delivery timestamps, login/logout events of users, friend invite events, infrastructure components (e.g., IP address) associated with user activity and/or a variety of other message data. Additionally, the message communication medium may allow users to make abuse reports against users, messages of users and/or message objects within messages. In this way, the message communication medium may maintain an abuse report log (e.g., abuse report log 404 of FIG. 4).

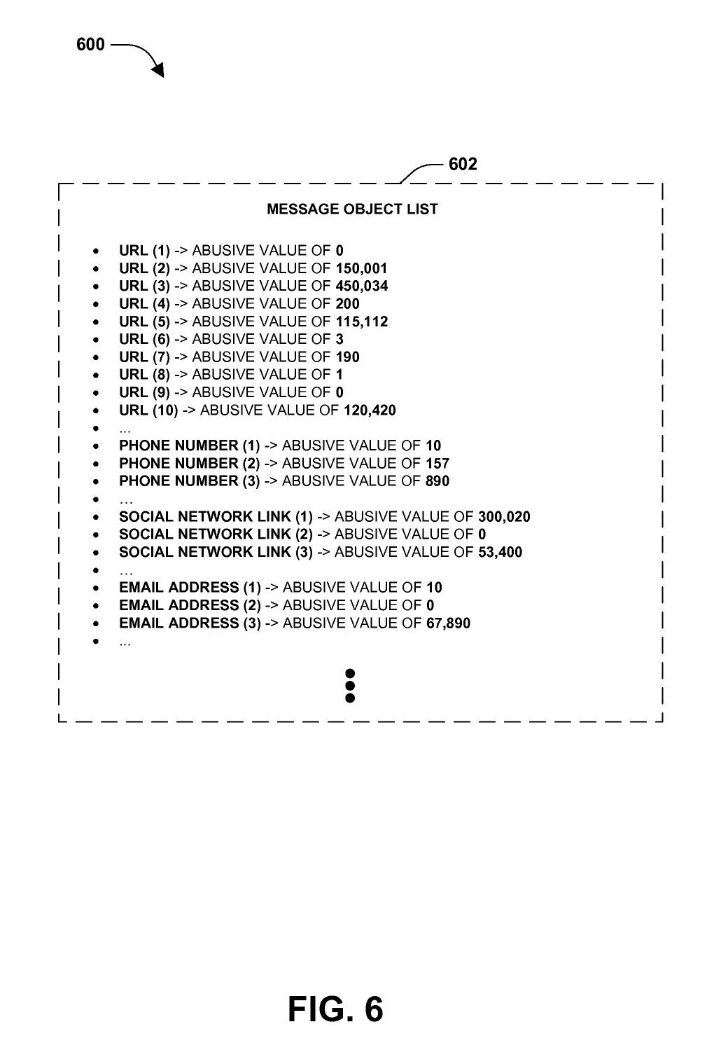

At 104, a message object list comprising one or more message objects used within messages of the message communication medium may be defined (e.g., message object list 602 of FIG. 6). For example, the communication history log may be parsed to identify message objects used within messages, which may be used to build the message object list. Abuse values may be associated with (e.g., linked to, but not necessarily component parts of) the respective message objects within the message object list. It may be appreciated that abuse values may also be associated with users and/or infrastructure components. It may be appreciated that abuse values may be specified and/or maintained within a variety of structures, such as the message object list, a separate database table, a separate data structure, a separate text file, etc. In this way, abuse values may be assigned and/or updated (e.g., incremented, decremented, reset, etc.) based upon aggregated abuse reports, account activity patterns, broadcast usage patterns and/or other factors associated with the message communication medium.

It may be appreciated that abuse values (e.g., for message objects, users and/or infrastructure components) may be in any of a variety of one or more forms. In one example, abuse values may comprise a score and/or probability indicative of “potential” abuse. That is, abuse values may be assigned to a wide variety of message objects, users and/or infrastructure components, ranging from non-abusive entities to suspect entities to abusive entities. For example, a first non-abusive user may be assigned a 1 out of 100 abuse value, a second non-abusive user may be assigned a 5 out of 100 abuse value, a suspect user may be assigned a 33 out of 100 abuse value, and an abusive user may be assigned a 76 out of 100 abuse value. In this way, potential abusive entities may be identified, for example, and not merely abusive entities. It may be appreciated that identifying different types of entities in this manner may allow, among other things, statistical analysis and/or techniques, etc. to be applied to reach certain verdicts (e.g., a value of 65 out of 100 may equate to an abusive entity at one point in time and/or under certain conditions, etc., whereas a value of 95 out of 100 may be required to regard an entity as abusive at a second point in time and/or under different conditions, etc.).

At 106, for respective abuse reports associated with one or more users of the message communication medium (e.g., abuse reports within an abuse report log), a reported user associated with an abuse report may be determined, at 108. A reported user may be a user against which an abuse report is made. At 110, one or more messages, comprising at least one message object, sent by the reported user may be identified (e.g., one or more messages within a time span of the abuse report, one or more messages sent from an unfamiliar location, etc.). For example, an abuse report against user A may have been made on Monday. Messages with at least one message object sent by user A within 5 days of Monday may be identified. It may be appreciated that a time span as used herein may cover a wide variety of time periods, such as an infinite time span (e.g., messages sent by the user since an account of the user was created), a finite time span (e.g., last 5 days), an elapsed time since a last login by a reported user, etc. Additionally, the one or more messages sent by the reported user may be identified based upon criteria other than time spans, such as messages sent by the reported user from an unfamiliar and/or unusual location (e.g., non-suspicious activity may be sent from an account logged in from Ohio for months, and then suddenly the account is logged in from Greenland with abuse reports, and thus messages sent from Greenland may be identified as suspicious as opposed to the messages from Ohio).

At 112, one or more abuse values within the message object list for message objects associated with one or more identified messages sent by the reported user may be incremented. That is, abuse values for message objects used within other messages sent by the reported user may be incremented because such message objects may be potentially abusive (e.g., within abusive messages). It may be appreciated that abuse values for message objects sent by the reported user within other messages may be incremented because there may be a high probability that the reported user may send other abusive message objects over time, even though such message objects may not have been reported (e.g., the reported user may have a propensity to send abusive messages because the reported user has already been reported in the abuse report). In one example, abuse values of the identified message sent by the reported user may be incremented on a sliding scale. For example, messages sent by the reported user within 10 days may be incremented by 5, while messages sent within 10 to 30 days may be incremented by 1.

In another example of incrementing abuse values for message objects, an abuse value for a message object may be assigned (e.g., updated, incremented, decremented, etc.) based upon a number of messages comprising the message object compared with a number of recipients invoking the message object within messages. For example, if a URL is sent within 500 messages, but merely 5 users click the URL, then the URL may be deemed to be abusive and/or at least uninteresting to users.

At 114, an abusive message object list may be defined based upon message objects within the message object list having abuse values above a threshold (e.g., message objects having an abuse value above 50). In this way, message objects, such as URLs, phone numbers, etc., that may be abusive and/or link to abusive content, such as spam websites, may be identified so that additional action(s), such as blocking such URLs, may be taken. Additionally, abusive users may be determined and/or abuse values may be assigned for users based upon the abusive message object list and/or other factors, such as account usage partners. In one example, a user may be identified as an abusive user based upon the user being associated with one or more abusive message objects defined with the abusive message object list (e.g., a user that has sent more than 10 abusive message objects within messages may be deemed to be an abusive user, a user that has sent messages with message objects comprising a cumulative abuse value above 50 may be deemed to be an abusive user, etc.). In another example, a user may be identified as an abusive user based upon abuse values assigned to the user (e.g., abuse values assigned to the user based upon the user sending messages comprising message objects defined within the abusive message object list). If a user is assigned an abuse value above a threshold, then the user may be deemed to be an abusive user.

It may be appreciated that a reported user (e.g., a user identified within an abuse report) may be determined to be an abusive user based upon one or more factors, such as broadcast usage patterns, unaccepted friend invites and/or account activity patterns, etc. In one example of identifying an abusive user, a user may be identified as an abusive user and/or assigned an abuse value based upon determining that the user is a reported user and is associated with a broadcast usage pattern within the message communication medium. For example, a communication history log may be queried to determine a broadcast usage pattern indicating that the reported user sends a number of messages without action by recipient users above a threshold (e.g., more than 90% of recipients do not respond, forward, click URLs within and/or perform other actions with regard to thousands of messages from a reported user).

In another example of identifying an abusive user, a user may be identified as an abusive user and/or assigned an abuse value based upon determining that the user is a reported user and a number of unaccepted friend invites from the user are above a predetermined threshold. For example, users of an instant message communication medium may be unable to have a conversation with one another unless the users are connected through a friend list. Thus, a user, such as a spammer, may send a large number of friend requests to other users, which may tend to ignore the friend requests because they do not know the requesting (e.g., abusive) user.

In another example of identifying an abusive user, a user may be identified as an abusive user based upon the user being a reported user and an account activity pattern of the user indicating that the user is associated with a number of logins above a threshold within a time span. That is, if a user logs into the message communication medium a large number of times within a short times span (e.g., 50 logins within a 24 hour period, where logins occur during the day and the middle of the night), then such an account activity pattern may indicate that the user account may be shared with one or more abusive users attempting to use the account to make a profit through spam (e.g., non-abusive users of an instant message application may not login during the middle of the night and during the day, non-abusive users may not login a thousand times a month, etc.). In another example of identifying an abusive user, a user may be identified as an abusive user based upon the user being a reported user and an account activity pattern of the user indicating that the user's account usage within a time span is above a threshold. For example, non-abusive human users may not send messages twenty-four hours a day for several consecutive days, whereas abusive non-human users, such as bots, may be configured to send messages at such at rate.

In another example of identifying an abusive user, a user may be identified as an abusive user based upon the user being a reported user and an account activity pattern of the user indicating that the user is associated with a number of logins from different IP address and/or different geographical locations above a threshold. For example, if a user account is logged in from twenty different IP address within two days, then such an account activity pattern may indicate that the user account may be shared with one or more abusive users attempting to use the account to make a profit through spam. In another example of identifying an abusive user, a user may be identified as an abusive user based upon the user being a reported user and an account activity pattern of the user indicating that the user is associated with a number of offline messages compared with online messages above a threshold. For example, if a user of an instant message communication medium sends a large number of offline messages compared to online messages, then such an account activity pattern may indicate that the user account is abusive because non-abusive users may generally use an account while online for conversations.

It may be appreciated that infrastructure components may be identified as abusive infrastructure components. That is, an infrastructure component may be identified as an abusive infrastructure component based upon determining that the infrastructure component is associated with an abusive user. In this way, URL rollups, hostnames, domains, IP address, IP ranges, name servers, site owners identified by autonomous system numbers and/or other components may be identified and/or blocked as abusive.

It may be appreciated that abuse may be detected across multiple message communication mediums. For example, abuse values for users, infrastructure components and/or message objects associated with (different) message communication mediums may be maintained and/or aggregated together. For example, abuse values assigned to a user of instant message communication may be updated based upon abusive activity of the user with regard to email communication.

A variety of actions may be taken against abusive users, message objects and/or infrastructure components. In one example, abusive accounts may be banned. In another example, a rate at which messages, such as instant messages, may be sent by an account may be throttled. In this way, abuse within message communication mediums may be detected and/or mitigated.

It may be appreciated that thresholding may be implemented when specifying abuse values and/or determining abuse (e.g., abusive users, abusive message objects, etc.) from abuse values. That is, abusive content may be discerned from non-abusive content based upon abuse ratios that may be applied to various abuse detection techniques, such as abuse report aggregation, account activity pattern evaluation, broadcast pattern evaluation, etc. Such threshold abuse ratios may be manually and/or automatically tuned and/or weighted. Additionally, statistical techniques such as hypothesis testing, analysis of variance, clustering, etc. may be implemented. In this way, results from a variety of abuse detection techniques may be combined. For example, manual tuning or weighting, regression statistical methods, and/or machine learning techniques, such as neural networks, maximum entropy, and/or Bayesian methods may be used to combine abuse detection results. At 110, the method ends. At 110, the method ends.

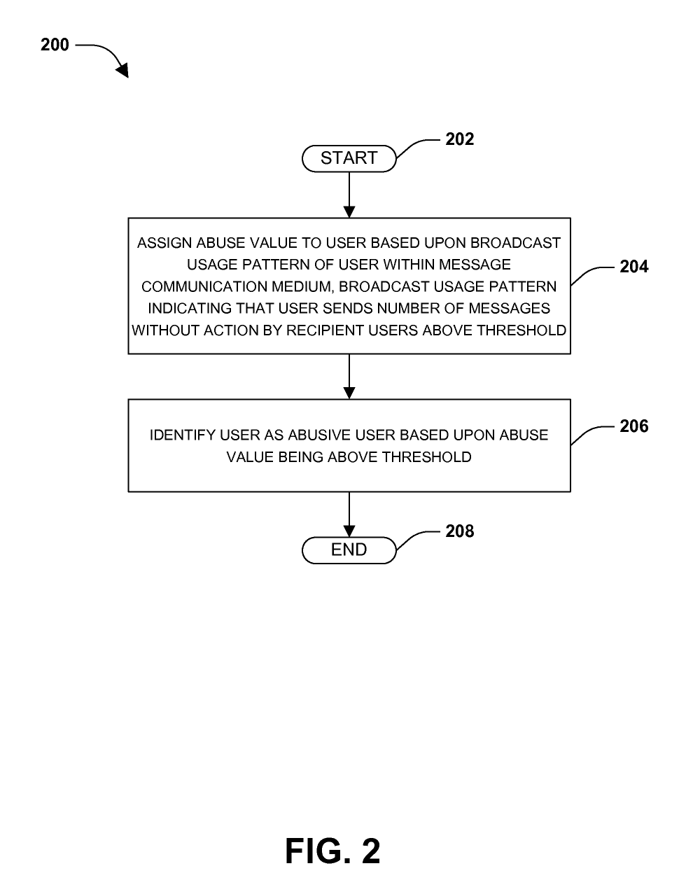

One embodiment of identifying an abusive user of a message communication medium is illustrated by an exemplary method 200 in FIG. 2. At 202, the method starts. At 204, an abuse value may be assigned to a user based upon a broadcast usage pattern of the user within a message communication medium, such an instant communication medium. The broadcast usage pattern may indicate that the user sends a number of message without action by recipient users above a threshold (e.g., a spammer may send thousands of spam-based messages to recipients that may not respond, forward, click URLs and/or take other action with respect to the messages).

It may be appreciated that abuse values may be assigned to users based upon a variety of factors. In one example, abuse values may be assigned to a user based upon an account activity pattern of the user. For example, abuse values may be assigned to a user where the account activity pattern is indicative of a number of logins within a time span above a threshold, a number of logins from different IP address and/or geographical locations above a threshold (e.g., logins from various distant locations within a short time frame), an account usage within a time span above a threshold (e.g., around the clock 24 hour usage), a number of offline messages compared with online messages above a threshold and/or other activity patterns. In another example, abuse values may be assigned to a user based upon the user being associated with one or more abusive message objects defined within an abusive message object list. The abusive message object list may have been defined based upon aggregating abuse report data of users of the message communication medium and/or other message communication mediums. In this way, the user may be identified as an abusive user based upon the abuse value being above a threshold, at 206. At 208, the method ends.

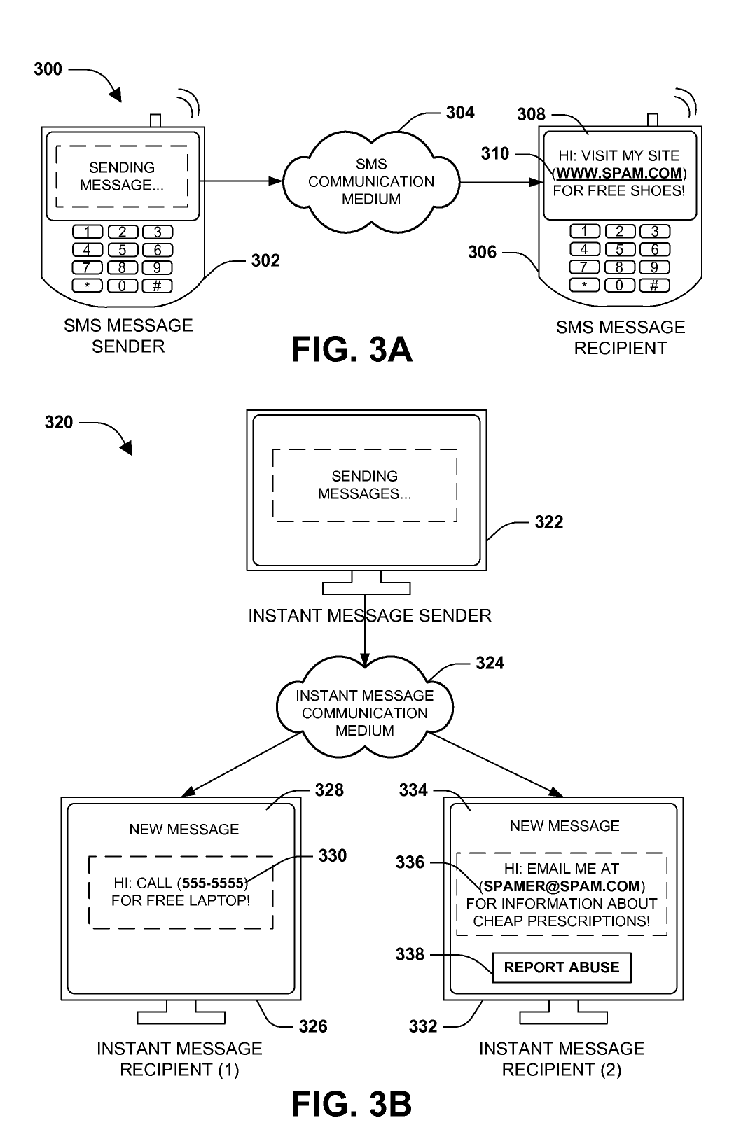

FIG. 3A illustrates an example 300 of a sender 302 sending a message 308 comprising a URL message object 310 to a recipient 306 using an SMS communication medium 304. The SMS communication medium 304 may allow users to send and/or receive messages on client devices, such as cell phones. Such messages may comprise message objects, such as text, URLs, images, phone numbers, email addresses, social network links and/or a variety of other objects. For example, the sender 302 may send the message 308 through the SMS communication medium 304 to the recipient 306. The message may comprise text, a URL message object 310 (e.g., www.spam.com linking to a malicious website) and/or other content. It may be advantageous to detect whether sender 302 and/or the URL message object 310 may be abusive (e.g., spam, malicious, uninteresting, etc.).

FIG. 3B illustrates an example 320 of a sender 322 sending a first message 328 comprising a phone number message object 330 to a first recipient 326, and a second message 334 comprising an email message object 336 to a second recipient 332 using an instant message communication medium 324. The instant message communication medium 324 may allow users to send and/or receive online and/or offline message, which may comprise message objects. For example, the sender 322 may send the first message 328 to the first recipient 326, and the second message 334 to the second recipient 332. The first message 328 may comprise text, the phone number message object 330 (e.g., 555-5555 that connects to a malicious phone service) and/or other content. The second message 334 may comprise text, the email message object 336 (e.g., spamer@spam.com associated with an email account of an abusive user) and/or other content. It may be advantageous to detect whether sender 322, the phone number message object 330 and/or the email message object 336 may be abusive.

Additionally, it may be advantageous to aggregate abusive reports made by users against messages, users and/or message objects. For example, the second recipient 332 may invoke a report abuse button 338 to report sender 322, message 334 and/or email message object 326 as abusive. Such abuse reports may be used to assign abuse values to users and/or message objects, which may be used to identify abuse.

FIG. 4 illustrates an example 400 of a communication history log 402 and an abuse report log 404. The communication history log 402 may comprise message data associated a message communication medium. The communication history log 402 may comprise message data, such as a message send event, a message receive event, message content, a login event, a logout event, infrastructure components associated with account activity (e.g., an IP address of a user login event), a friend request event, and/or a plethora of other message events and/or data. In one example, the communication history log 402 may comprise a first message send event 406 indicating that user (X) sent a message to user (D) comprising a URL (2) message object. In another example, the communication history log 402 may comprise a second message send event 408 indicating that user (Y) sent a message to user (F) comprising the URL (2) message object. Information within the communication history log 402 may be used to indentify abusive users, message objects and/or infrastructure component. In one example, a message object list (e.g., message object list 602 of FIG. 6) may be defined based upon the communication history log 402. Abuse reports may be aggregated to assign abuse values to message objects defined within the message object list. In another example, account usage patterns, friend request patterns, broadcast usage patterns and/or other factors associated with users and/or message objects may be extracted from the communication history log 402.

The abuse report log 404 may comprise a plurality of abuse reports from users reporting abusive activity regarding users, messages and/or message objects. In one example, the abuse report log 404 may comprise a first abuse report 410 indicating that user (D) reported user (X) concerning URL (2) message object. In another example, the abuse report log 404 may comprise a second abuse report 412 indicating that user (F) reported user (Y) concerning URL (2) message object. The abuse reports within the abuse report log 404 may be aggregated to identify abusive users, abusive message objects (e.g., an abusive message object list) and/or abusive infrastructure components. For example, URL (2) message object, URL (3) message object, URL (4) message object, URL (7) message object, URL (10) message object and/or other message objects may be determined as abusive message objects based upon aggregating the abuse report log 404 (e.g., abuse values for message objects within messages sent by user (X) may be incremented based upon the first abuse report 410, abuse values for message objects within messages sent by user (Y) may be incremented based upon the second abuse report 412, etc.). Additionally, users may be determined as abusive based upon aggregating the abuse report log 404. For example, user (X), user (Y), user (U), user (T), user (S), user (O) and/or other users may be determined as abusive users because such users may have sent a number of messages comprising abusive message objects above a threshold.

In one example, aggregating abuse reports may be used to identify abusive users that have not been reported in an abuse report. For example, the abuse report log 404 may comprise no abuse reports against user (Z). However, user (Z) may have sent messages comprising URL (2) message object and/or URL (3) message object, which may have been determined as abusive message objects. In this way, user (Z) may be identified as an abusive user because user (Z) sent messages comprising abusive message objects (e.g., URL (2) message object, URL (3) message object and/or other message objects within an abusive message object list).

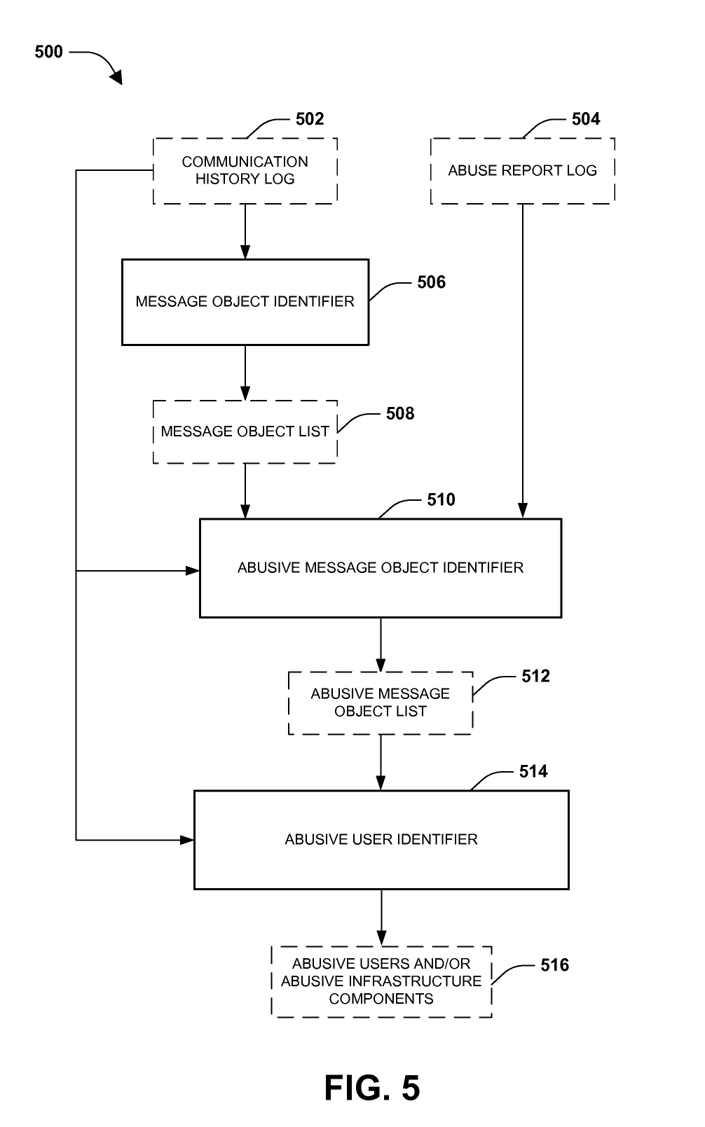

FIG. 5 illustrates an example of a system 500 configured to identify abusive user(s), infrastructure component(s) and/or message object(s) used within messages by users of a message communication medium. The system 500 may comprise a message object identifier 506, an abusive message object identifier 510, and/or an abusive user identifier 514. The system 500 may be associated with a communication history log 502 (e.g., 402 of FIG. 4) and/or an abuse report log 504 (e.g., 404 of FIG. 4) of the message communication medium. The message object identifier 506 may be configured to define a message object list 508 (e.g., 602 of FIG. 6) comprising one or more message objects used within messages of the message communication medium, which may be defined based upon entries within the communication history log 502 (e.g., 402 of FIG. 4). The message objects within the message object list 508 may be associated with abuse values (e.g., reputational data associated with abusive behavior and/or content used within the message communication medium).

The abusive message object identifier 510 may be configured to aggregate abuse reports within the abuse report log 504. In particular, for respective abuse reports within the abuse report log 504, the abusive message object identifier 510 may determine a reported user associated with an abuse report. The abusive message object identifier 510 may identify one or more messages, comprising at least one message object, sent by the reported user within a (predetermined) time span of the abuse report. For example, the abusive message object identifier 510 may query the communication history log 502 for messages sent by the reported user within 20 days of the abuse report. The abusive message object identifier 510 may increment one or more abuse values within the message object list 508 for message objects associated with the one or more identified messages sent by the reported user (e.g., the reported user may have sent messages comprising used URL (1) message object, URL (3) message object, URL (30) message object, phone number (1) message object, email address (5) message object, etc. within 20 days of the abuse report, and thus abuse values of such message objects may be increment because such message objects may be abusive). In this way, the abusive message object identifier 510 may define an abusive message object list 512 based upon message objects within the message object list 508 having abuse values above a threshold. It may be appreciated that a message object (e.g., with a corresponding abuse value (e.g., initially set to zero)) may be added to the message object list 508, if not already in the list, prior to incrementing an abuse value for that object.

The abusive user identifier 514 may be configured to identify a user as an abuse user (e.g., abusive user and/or infrastructure 516) based upon the user being associated with one or more abusive message objects defined within the abusive message object list 512. The abusive user identifier 514 may, for example, be configured to identify a user as an abusive user (e.g., abusive user and/or infrastructure 516) based upon determining that the user is a reported user (e.g., the user has been reported by an abuse report within the abuse report log 504) and is associated with a broadcast usage pattern within the message communication medium (e.g., a usage pattern indicating that the user sends a number of messages without action by recipient users above a threshold). The abusive user identifier 514 may be configured to identify an infrastructure component as an abusive infrastructure component (e.g., abusive user and/or infrastructure 516) based upon determining the infrastructure component is associated with an abusive user.

FIG. 6 illustrates an example 600 of a message object list 602. The message object list 602 may be defined based upon message data associated with a message communication medium (e.g., message data extracted from a communication history log (e.g., 402 of FIG. 4)). In particular, the message object list 602 may comprise message objects comprised within messages sent and received by users of the message communication medium. For example, message objects may comprise URLs, phone numbers, email addresses, social network links and/or a plethora of other objects. Message objects within the message object list 602 may be associated with abuse values. For example, URL (1) message object may be associated with an abuse value of 0 because reported users (e.g., users identified within an abuse report) may not have sent URL (1) message object within messages, and thus the abusive value of URL (1) message object was never incremented during abuse report aggregation. Thus, the URL (1) message object may not be deemed to be abusive. In contrast, URL (3) message object may be associated with an abuse value of 450,034 because reported users may have sent URL (3) message object within messages, and thus the abuse value of URL (3) message object may have been incremented numerous times during abuse report aggregation (e.g., even though an abuse report was not made/received for each message within which URL (3) message object was comprised). Thus, URL (3) message object may be deemed to be abusive.

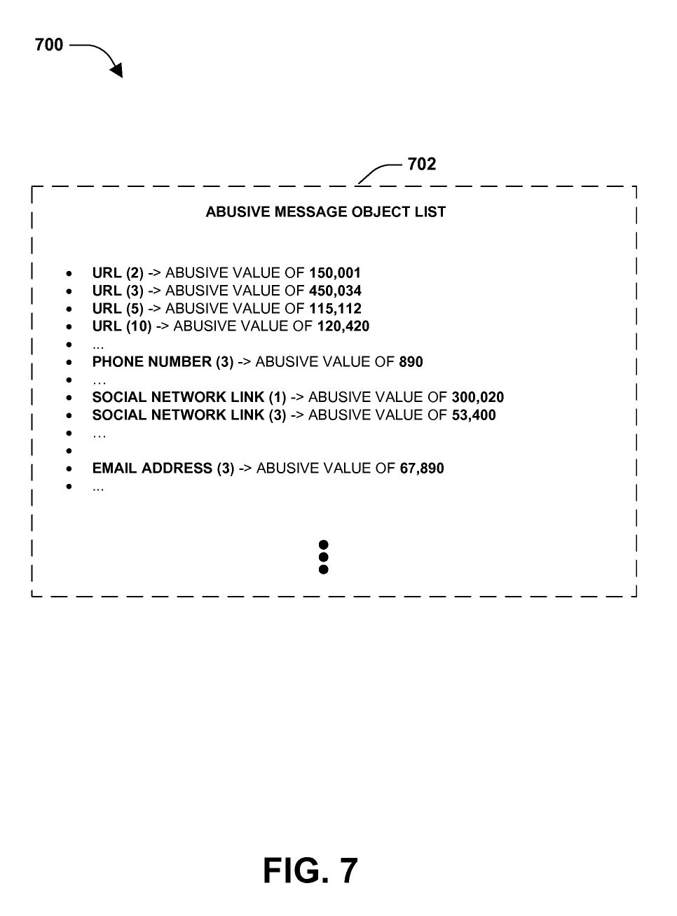

FIG. 7 illustrates an example 700 of an abusive message object list 702. The abusive message object list 602 may have been defined based upon a message object list (e.g., message object list 602 of FIG. 6). In particular, message objects within the message object list having abuse values above a threshold may be defined within the abusive message object list 702 because such message objects may be deemed as abusive and/or link to abusive content. In this way, abusive message objects may be identified and/or defined within the abusive message object list 702. Additionally, users may be identified as abusive users based upon being associated with abusive message objects within the abusive message object list 702.

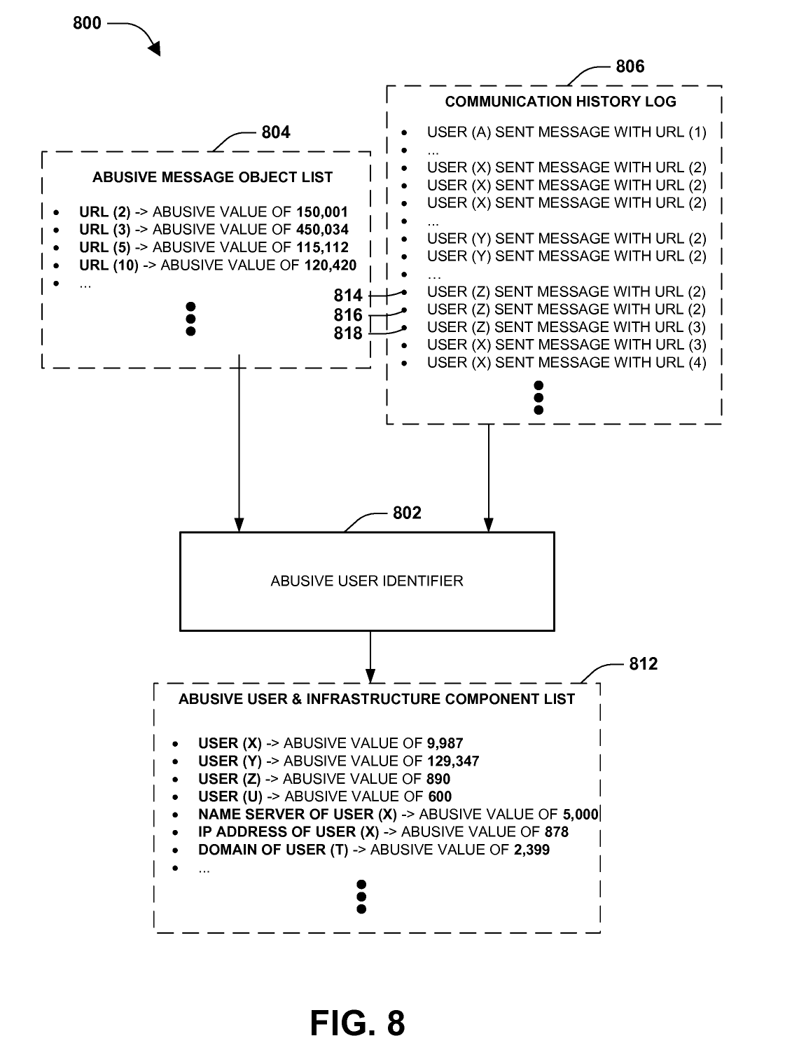

FIG. 8 illustrates an example 800 of an abusive user identifier 802 (e.g., 514 of FIG. 5) defining an abusive user and infrastructure component list 806 (e.g., 516 of FIG. 5). The abusive user identifier 802 may be configured to identify abusive users of a message communication medium based upon users having sent messages comprising abusive message objects defined within an abusive message object list 804 (e.g., 702 of FIG. 7). The abusive message object list 804 may have been defined based upon aggregating abuse reports against users, messages and/or message objects associated with the message communication medium (and/or additional communication medium(s)). In one example, the abusive message object list 804 may comprise URL (2) message object, URL (3) message object, URL (5) message object, URL (10) message object and/or other messages objects identified as abusive message objects based upon aggregating abuse reports.

The abusive user identifier 802 may identify user (X), user (Y), user (Z), user (U), and/or other users as being abusive users based upon determining within a communication history log 806 (e.g., 402 of FIG. 4) that the users sent messages comprising abusive message objects within the abusive message object list 804. For example, user (X) may be identified as an abusive user because user (X) may have sent one or more messages comprising URL (2) message object, URL (3) message object and/or other message objects identified as abusive message objects within the abusive message object list 804. User (Y) may be identified as an abusive user because user (Y) may have sent one or more messages comprising URL (2) message object and/or other message objects identified as abusive message objects within the abusive message object list 804.

It may be appreciated that a user may be identified as an abusive user even though an abuse report may not have been made against the user. For example, even though user (Z) was not reported in an abuse report, user (Z) may be identified as an abusive user because user (Z) may have sent one or more messages comprising message objects within the abusive message object list 804 (e.g., message 814 comprising URL (2) message object, message 816 comprising URL (2) message object, message 818 comprising URL (3) message object, etc.). Additionally, the abusive user identifier 802 may identify infrastructure components as abusive infrastructure components based upon infrastructure components associated with abuse users (e.g., name server of user (X), IP address of user (X), domain of user (T), etc.). It may be appreciated that in one example, abuse values may be assigned to users and/or infrastructure components, which may be used to identify abuse. In this way, the abusive user and infrastructure component list 812 may be defined.

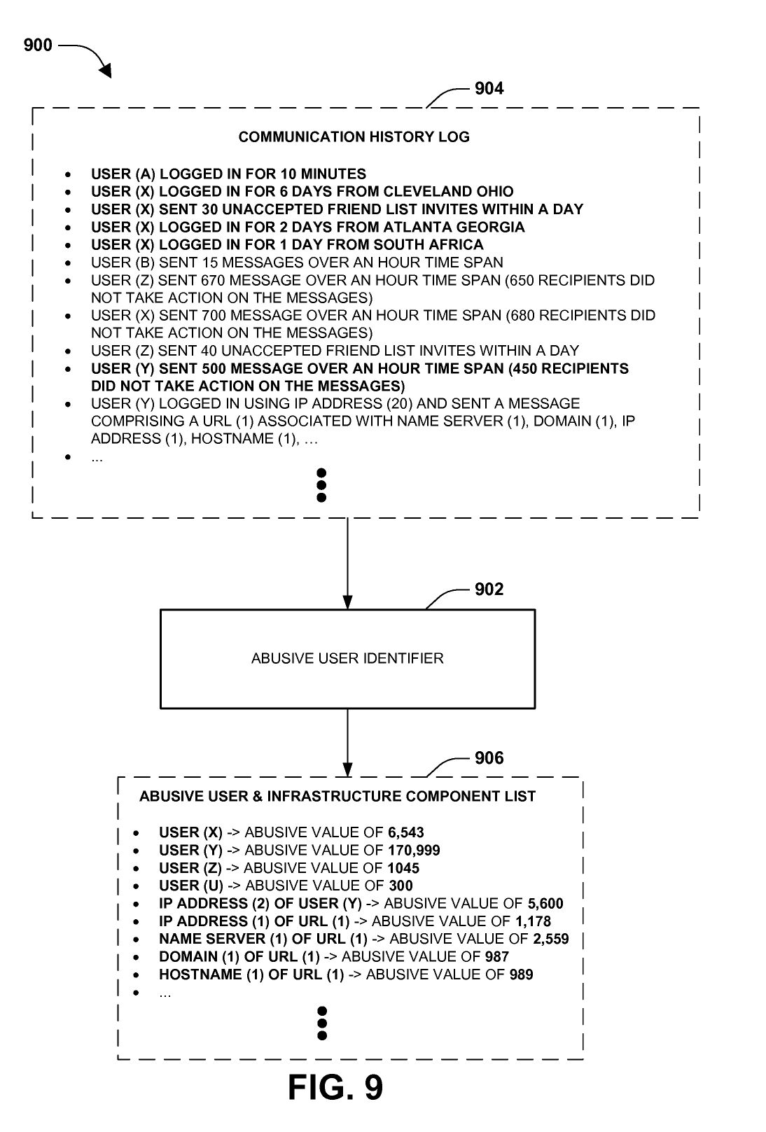

FIG. 9 illustrates an example 900 of an abusive user identifier 902 (e.g., 514 of FIG. 5) defining an abusive user and infrastructure component list 906 (e.g., 516 of FIG. 5). One or more message communication mediums may allow users to send and receive messages. A communication history log 904 (e.g., 402 of FIG. 4) may record message data associated with one or more of the one or more message communication mediums. For example, the communication history log 904 may comprise user login events (e.g., user (A) logged in for 10 minutes), friend invite events (e.g., user (X) sent 30 unaccepted friend lists invites within a day), account activity data (e.g., user (Y) logged in using IP address (20)) and/or a plethora of other data associated with the message communication medium.

The abusive user identifier 902 may be configured to identify abusive users and/or infrastructure components based upon identifying usage patterns of users of a message communication medium. Such usage patterns may be identified based upon parsing the communication history log 904. In one example, a broadcast usage pattern may be identified for user (Y) based upon determining within the communication history log 904 that user (Y) sent 500 messages within an hour time span, and that 450 recipients did not take action on the messages. The broadcast usage pattern may indicate that user (Y) is an abusive user, and thus an abusive value for user (Y) may be assigned and/or incremented to 170,999. In another example, a first account activity pattern may be identified for user (X) based upon determining within the communication history log 904 that user (X), within a 9 day time span, logged in for 6 days from Cleveland Ohio, and then 2 days from Atlanta Ga., and then 1 day from South Africa. The first account activity pattern may indicate that user (X) may be an account used by multiple abusive users to send abusive content, and thus an abusive value for user (X) may be assigned and/or incremented. In another example, a second account activity pattern may be identified for user (X) based upon determining within the communication history log 904 that user (X) sent 30 unaccepted friend list inventes within a day. The second account activity pattern may indicate that user (X) may be an abusive user attempting to join other user friend lists so that user (X) may send abusive content to such users, and thus an abusive value for user (X) may be assigned and/or incremented (e.g., incremented to 6,543). It may be appreciated that a variety of usage patterns indicative of abuse may be identified from the communication history log 904. In this way, the abusive user and infrastructure component list 906 may be defined.

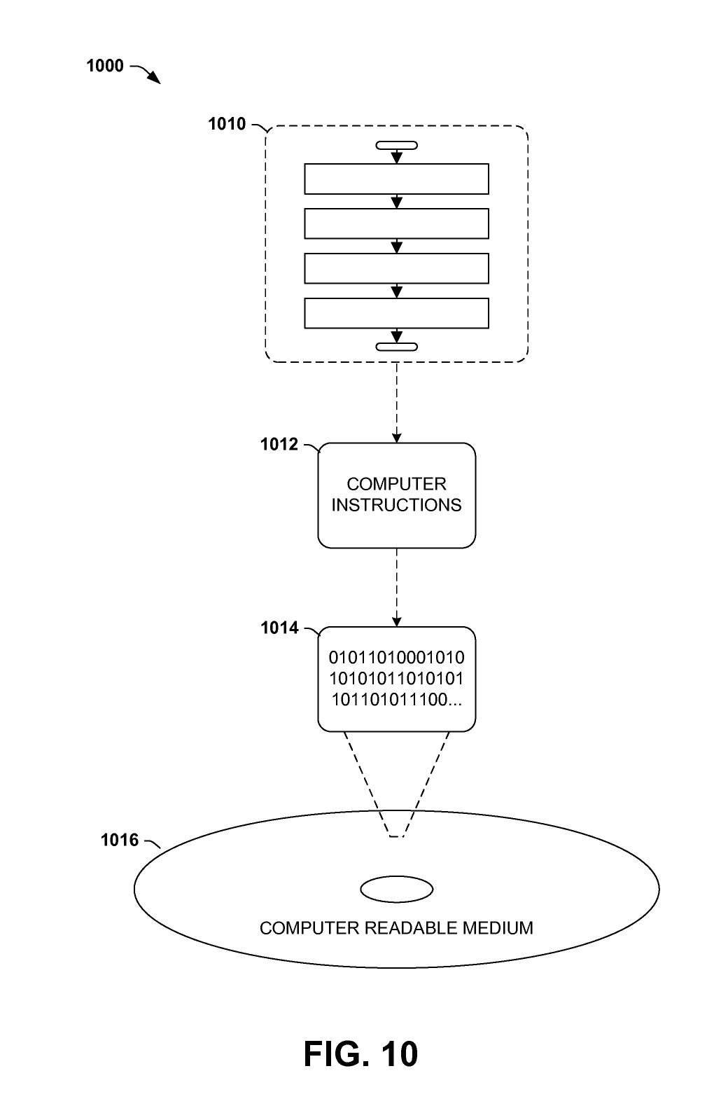

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1016 (e.g., a CD-R, DVD-R, or a platter of a hard disk drive), on which is encoded computer-readable data 1014. This computer-readable data 1014 in turn comprises a set of computer instructions 1012 configured to operate according to one or more of the principles set forth herein. In one such embodiment 1000, the processor-executable computer instructions 1012 may be configured to perform a method 1010, such as at least some of the exemplary method 100 of FIG. 1 and/or exemplary method 200 of FIG. 2, for example. In another such embodiment, the processor-executable instructions 1012 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

It may be appreciated that at least one of A and B and/or the like generally means A or B or both A and B.

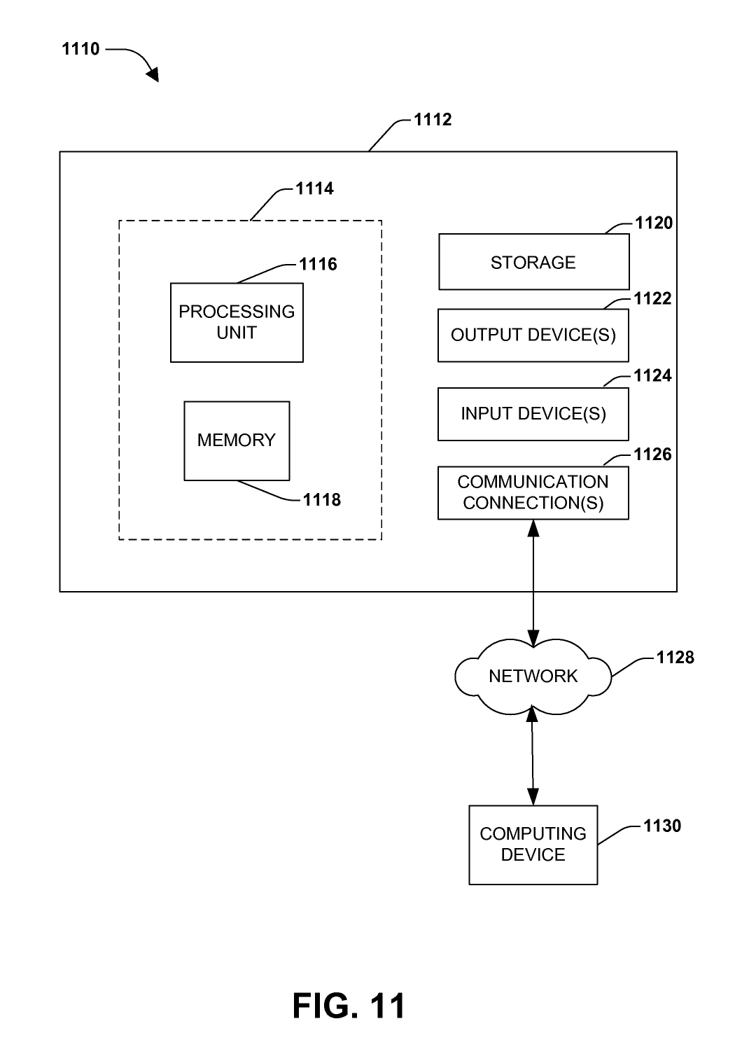

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for identifying abusive message objects used within messages, comprising:
defining a message object list comprising one or more message objects used within messages of a message communication medium, a message object within the message object list associated with an abuse value;
for respective abuse reports associated with one or more users of the message communication medium:
determining a reported user associated with an abuse report;
identifying one or more messages sent by the reported user, an identified message comprising at least one message object; and
incrementing one or more abuse values within the message object list for message objects associated with one or more identified messages sent by the reported user; and
defining an abusive message object list based upon message objects within the message object list having abuse values above a threshold.

2. The method of claim 1, a message object comprising at least one of a URL, a phone number, an email address, and a social network link.

3. The method of claim 1, the message communication medium comprising at least one of instant message communication, email communication, social network communication, and SMS communication.

4. The method of claim 1, comprising:
identifying a user as an abusive user based upon the user being associated with one or more message objects defined within the abusive message object list.

5. The method of claim 4, comprising:
identifying an infrastructure component as an abusive infrastructure component based upon determining the infrastructure component is associated with the abusive user, the infrastructure component comprising at least one of a URL rollup, a hostname, a domain, an IP address associated with a login of the abusive user, an IP address associated with a message sent by the abusive user, an IP address associated with a website that hosts a URL, an IP address associated with a host that hosts a URL, an IP range, a name server, and a site owner associated with an autonomous system number.

6. The method of claim 1, comprising:
identifying a user as an abusive user based upon determining that the user is a reported user and is associated with a broadcast usage pattern within the message communication medium, the broadcast usage pattern indicating that the user sends a number of messages without action by recipient users above a threshold.

7. The method of claim 1, comprising:
identifying a user as an abusive user based upon the user being a reported user and a number of unaccepted friend invites from the user above a threshold.

8. The method of claim 1, comprising:
identifying a user as an abusive user based upon the user being a reported user and an account activity pattern of the user indicative of at least one of:
a number of logins within a time span above a threshold;
a number of logins from different IP addresses above a threshold;
a number of logins from different geographical locations above a threshold;
account usage within a time span above a threshold; and
a number of offline messages compared with online messages above a threshold.

9. The method of claim 1, comprising:
assigning an abuse value to a user based upon the user being associated with one or more message objects defined within the abusive message object list.

10. The method of claim 9, comprising:
updating the abuse value of the user based upon the user being associated with an abusive message behavior pattern associated with a second message communication medium.

11. The method of claim 9, comprising:
throttling a message send rate associated with the user based upon the abuse value.

12. The method of claim 1, comprising:
assigning an abuse value to a message object within the message object list based upon a number of messages comprising the message object compared with a number of recipients invoking the message object within messages.

13. A computer readable medium comprising computer executable instructions that when executed via a processing unit perform a method for identifying an abusive user of a message communication medium, comprising:
assigning an abuse value to a user based upon a broadcast usage pattern of the user within a message communication medium, the broadcast usage pattern indicating that the user sends a number of messages without action by recipient users above a threshold; and
identifying the user as an abusive user based upon the abuse value being above a threshold.

14. The method of claim 13, the message communication medium comprising instant message communication.

15. The method of claim 13, comprising:
assigning the abuse value based upon an account activity pattern of the user indicative of at least one of:
a number of logins within a time span above a threshold;
a number of logins from different IP addresses above a threshold;
a number of logins from different geographical locations above a threshold;
account usage within a time span above a threshold; and
a number of offline messages compared with online messages above a threshold.

16. The method of claim 13, comprising:
assigning the abuse value based upon the user being associated with one or more abusive message objects defined within an abusive message object list, the abusive message object list based upon aggregated abuse report data of users of the message communication medium.

17. A system for identifying abusive message objects used within messages by users of a message communication medium, comprising:
a message object identifier configured to:
define a message object list comprising one or more message objects used within messages of a message communication medium, a message object within the message object list associated with an abuse value;
an abusive message object identifier configured to:
for respective abuse reports associated with one or more users of the message communication medium:
determine a reported user associated with an abuse report;
identify one or more messages sent by the reported user, an identified message comprising at least one message object; and
increment one or more abuse values within the message object list for message objects associated with one or more identified messages sent by the reported user; and
define an abusive message object list based upon message objects within the message object list having abuse values above a threshold.

18. The system of claim 17, comprising:
an abusive user identifier configured to:
identify a user as an abusive user based upon the user being associated with one or more message objects defined within the abusive message object list.

19. The system of claim 17, comprising:
an abusive user identifier configured to:
identify a user as an abusive user based upon determining that the user is a reported user and is associated with a broadcast usage pattern within the message communication medium, the broadcast usage pattern indicating that the user sends a number of messages without action by recipient users above a threshold.

20. The system of claim 18, the abusive user identifier configured to:
identify an infrastructure component as an abusive infrastructure component based upon determining the infrastructure component is associated with the abusive user, the infrastructure component comprising at least one of a URL rollup, a hostname, a domain, an IP address associated with a login of the abusive user, an IP address associated with a message sent by the abusive user, an IP range, a name server, and a site owner associated with an autonomous system number.
